(19) United States
(12) Patent Application Publication
(10) Pub. No.: US 2002/0188492 A1
(43) Pub. Date: Dec. 12, 2002

(54) Food-making, -delivery, and -carry-out system and method

(76) Inventor: Robert L. Borton, Rochester Hills, MI (US)

Correspondence Address: Brian S. Pickell, Bliss McGlynn, P.C., Suite 600, 2075 West Big Beaver Road, Troy, MI, 48084, US

(21) Appl. No.: 10/167,609

(22) Filed: Jun. 11, 2002

Related U.S. Application Data
(60) Provisional application No. 60/297,413, filed on Jun. 11, 2001.

(51) Int. Cl. G06F 17/60

(52) U.S. Cl. 705/8

(57) ABSTRACT

A system and method for strategical making, delivery, and carry-out of food orders for use by a store in the business of making, delivering, and permitting carry-out of food such that the food is optimally fresh upon delivery to and carry-out by customers of the store includes a display. The system and method also includes taking and entering into the system new orders from customers of the store for making, delivery, and carry-out of food. The system further forms groups of the new and pending delivery orders such that the orders of each group have substantially compatible delivery routes or locations. The system further determines strategically the sequence and timing in which the new and pending delivery and carry-out orders or groups of orders will be made and delivered to delivery customers and picked-up by carry-out customers, respectively, such that the orders are delivered and ready for pick-up in a substantially minimum amount of time upon completion of making the orders. The system further displays the next order or group of orders to be made according to the determination.

### CROSS-REFERENCE TO A RELATED APPLICATION

This application claims benefit of U.S. Provisional Patent Application 60/297,413 filed on Jun. 11, 2001 and entitled “Food-Making, -Delivery, and -Carry-Out System.”

### BACKGROUND OF THE INVENTION

1. Field of the Invention

The present invention relates, generally, to a system and method that assists in operation of a store for making, delivering, and carrying-out food and, more particularly, to such a system and method that determines sequence and timing of such making, delivery, and carry-out.

2. Description of the Related Art

At a store that makes, delivers, and permits the carry-out of food, the food is generally prepared by cooks, for example, of the store in the order in which orders for the food are placed by customers of the store. Also, the orders are filled without any calculated delay between filling of adjacent orders. And, such a store receives dine-in, delivery, and carry-out orders from customers often at random. As a result, although there are time periods when no orders are taken, there are also time periods when there are many orders taken, making it nearly impossible to fill each order instantly upon taking the order. As such, the cooks commonly get backed-up; that is, there may be several orders for food that have not been filled.

Also, inefficient making, delivery, and carry-out of food—for example, pizza—can have detrimental effects upon the delivery and carry-out customers. Specifically, such inefficiency results in pizza that is not hot and fresh upon delivery and pick-up thereof. The taste of the pizza may, therefore, be compromised.

By way of example, suppose the store receives ten orders for delivery. When the first order is out of an oven and in a delivery bag, a delivery driver sometimes recognize that the first and tenth orders form a “double” based upon location, the first and tenth deliveries being only two minutes apart. But, since the tenth order has not even been made, the driver often leaves the store and comes back to it to pick-up the tenth order or leaves it for another delivery driver to handle such that the first order does not become too old. Thus, two trips to locations proximate each other must be made when only one trip may be necessary.

It is known to use a dispatch screen to note the orders a particular delivery driver has taken such that the store knows how much to charge the driver when he or she cashes-in. The dispatch screen can also reveal orders a particular driver should deliver based upon the locations of the deliveries and the times the corresponding orders were taken by the store.

Computer programs designed to assist stores in managing making, delivery, and carry-out of, say, pizza, are also known. Generally, these computer programs compel cooks to prepare pizzas immediately upon receipt of the corresponding orders and in sequential order. As such, the cooks prepare the pizzas in the order that the cooks receive the orders placed for the pizzas.

And, although these programs are designed to consider “future time” orders, whereby a ticket or information identifying an order for pizza by a customer is printed by or displayed on, respectively, a computer at a predetermined time before the customer wants to pick-up the pizza or have it delivered to him or her, these programs generally are not designed to consider the optimal sequence in which the pizzas should be prepared and time they should be prepared. In addition, these programs generally are not designed to consider strategic delivery of the pizzas to maximize efficiency of the delivery process. This lack of strategy reduces the number of sales of pizza and the attendant revenue and profit of the stores.

In view of the above, it would be advantageous to prioritize from the back-log of orders those that need to be filled immediately. By delaying preparation of delivery orders that cannot or should not be delivered by drivers because the locations of the deliveries are remote with respect to each other, orders of carry-out customers can frequently be made faster, thereby reducing average carry-out times. By also preventing two drivers from going to locations proximate with respect to each other, the store gains the extra labor of a driver to conduct multiple tasks, thus reducing the need for extra staff and enabling reduction of labor costs. In addition, this extra labor may prevent customers who have been “on hold” longer than they are willing to wait from hanging-up on calls, which can cost the store lost revenue.

Furthermore, by reminding drivers that an order needs beverages by displaying that information on a dispatch screen, fewer return trips to the store by the drivers would be made to pick-up forgotten beverages, thereby also saving labor. Moreover, there would be fewer canceled beverage orders from customers who no longer want the untimely pop delivery, thus increasing beverage sales.

It would be advantageous as well to make decisions in connection with delivery and carry-out of pizza before preparation thereof and not based upon the time the corresponding order was taken by the store. Rather, such decisions should be made according to the sequence of the orders filled and the proximity in time that they were actually made relative to each other.

There is no system in the related art that informs cooks how to strategically organize ticket orders for pizza before filling them or how long the cooks should delay filling of certain orders to optimize temperature and, consequently, taste of the pizza. This inefficiency often causes a significant waste of labor, especially, with reference to the above example, if the first and tenth deliveries, which are located in the same area, are located far away from the store. More specifically, if the first order is a delivery ten minutes away, it takes twenty minutes to complete a round-trip. In this scenario, the first and tenth deliveries can take a total of forty minutes of labor to complete.

In light of this, more efficient making, delivery, and carry-out of pizza mandate a new and more sophisticated system of making, delivering, and carrying-out pizza.

### BRIEF SUMMARY OF THE INVENTION

The present invention overcomes the disadvantages in the related art in a system and method (system) for strategical making, delivery, and carry-out of food orders for use by a store in the business of making, delivering, and permitting carry-out of food such that the food is optimally fresh upon delivery to and carry-out by customers of the store. The system includes a display and takes and enters into the system new orders from customers of the store for making, delivery, and carry-out of food. The system further forms groups of the new and pending delivery orders such that the orders of each group have substantially compatible delivery routes or locations. The system further determines strategically the sequence and timing in which the new and pending delivery and carry-out orders or groups of orders will be made and delivered to delivery customers and picked-up by carry-out customers, respectively, such that the orders are delivered and ready for pick-up in a substantially minimum amount of time upon completion of making the orders. The system further displays the next order or group of orders to be made according to this determination.

One advantage of the food-making, -delivery and carry-out system and method of the present invention is that it permits food to be made, delivered, and carried-out in a strategic order and with strategic time delays to ensure optimal temperature and freshness of the food to be delivered or picked-up.

Another advantage of the food-making, -delivery and -carry-out system and method of the present invention is that it reduces delivery times.

Another advantage of the food-making, -delivery and carry-out system and method of the present invention is that it increases the number of deliveries a store can make in a given time.

Another advantage of the food-making, -delivery and carry-out system and method of the present invention is that it increases sales of food.

Another advantage of the food-making, -delivery and -carry-out system and method of the present invention is that it more accurately predicts when food will be delivered or ready for pick-up.

Another advantage of the food-making, -delivery and -carry-out system and method of the present invention is that it enables a reduction of labor costs of a store.

Another advantage of the food-making, -delivery and carry-out system and method of the present invention is that it can be implemented in a computer program and carried-out on a computer system.

Other objects, features, and advantages of the present invention will be readily appreciated as the same becomes better understood after reading the subsequent description.

### DETAILED DESCRIPTION OF PREFERRED EMBODIMENTS OF THE INVENTION

The present invention overcomes the disadvantages in the related art in a food-making, -delivery, and carry-out system and method (system) to be used by a store in the business of making, delivering, and permitting carry-out of food. The system is designed to determine the optimal sequence and timing of making, delivery, and carry-out of orders for the food such that average delivery times and the time it takes for the food to travel from oven to customer are reduced. The determination is based upon many factors, including, but not limited to, routes and locations of the orders' deliveries and expected arrival times of returning delivery drivers to the store.

The system includes a display and is preferably implemented in a computer program and carried-out on a computer system that includes at least a computer having a memory, a processor, the display, such as a monitor, and a user-input mechanism, such as a mouse or a keyboard. However, those having ordinary skill in the art will appreciate that the computer system can include any suitable number and kind of elements and is conventional and known in the art. And, although the present invention will be described below in connection with the making and delivery and/or carry-out of pizza-related products, those having ordinary skill in the art will also appreciate that the system can be used in connection with any type of food to be made and delivered and/or carried-out.

The program is used to strategically organize the orders from a backlog of orders into groups or clusters. With respect to delivery orders, the program forms these groups from orders recognized by the program as compatible. Then, the program sends the orders to cooks thereof in the order in which the food will likely be delivered. Each group must comprise at least one food item, but preferably a plurality of items the deliveries of which have driving routes and/or locations in common. A computer monitor, preferably, displays the orders.

After the cooks complete an order, they trip a laser or the equivalent of a “<next button>” to indicate to the program that the food has been made and put into an oven, for instance. Then, the program selects from the remaining backlog of orders the next order for completion and shows it on the screen of the monitor. When that order is completed, the cooks again trip the laser or the “<next button>” such that the next order for completion will be displayed on the monitor screen.

When an order appears on the screen, a ticket for that order is simultaneously printed. The ticket has the address of the customer and the order information that aids in identifying the items belonging to the customer's order. The next order to appear and, thus, be made may not be the one next in the order in which the orders were taken, as with the programs of the related art.

For example, if the cooks just finish making the first of ten orders and then hit the “<next button>,” the next order to appear for production may be the tenth order. Orders two through nine are skipped if the first and tenth orders are recognized by the program as making a good “double” based upon their delivery locations' proximity to each other or common driving distances. Thus, the cooks make these two orders back to back. The driver taking these two delivery orders does not have to wait for the cooks to make orders two through nine before he or she starts delivering, as with the programs of the related art. As a result, the food will be on the road faster, leaving less time for the food to become cooler and mushier while the cooks finish orders two through nine.

Referring back to the example above in “Description of the Related Art,” if the first and tenth orders are made back to back, a store can save up to eighteen minutes of labor and reduce the delivery time of the tenth order also by several minutes. In nearly every situation using systems of the related art, the tenth delivery arrives later than if it were made second, as just described. Accordingly, when the present invention is used, the first and tenth orders often sit on a shelf less time before they are delivered, the tenth order is delivered faster, and the store often gains extra labor from the driver for other purposes.

Alternatively, if the first order is made and the second order is a carry-out order, the carry-out order may be made next if the store desires timely carry-out orders. In that case, the program prompts preparation of the tenth order as soon as the next delivery order is scheduled to be made. So, the first and tenth orders are the next two delivery orders made even though they may not be made successively. Carry-out orders may be made between them. In other words, the tenth order is made before any other delivery orders is/are made. For example, if the third order is the next delivery order, but is not compatible with the first order, the third order is skipped and the tenth order, which is compatible with the first order, is substituted in place of the third order. So, the first, second, and tenth orders are made successively.

Alternatively, the first and tenth delivery orders and a compatible eleventh delivery order are made successively. Now, if the second and third orders are also delivery orders that have two compatible deliveries each, nine orders can potentially be made before the fourth order is tended to. If the fourth order is from a carry-out-customer who arrives on time, the customer may have to wait significantly longer for his or her order than his or her quoted time. To minimize or eliminate this problem, when a delivery order is bumped ahead in the line, the program pushes each of the remaining delivery orders in the system back the same number of positions as the number of delivery orders pushed to the head of the line.

For example, the first, second, third, sixth, tenth, and eleventh orders are currently all the delivery orders in the system while the fourth, fifth, seventh, eighth, and ninth orders are currently all the carry-out orders in the system. After the first order is made, the program recognizes that the first order is compatible with the tenth and eleventh orders. So, the tenth and eleventh orders are made next. Now, the second order, a delivery order, is the oldest order in the store. But, the second order is not made next because each of the remaining delivery orders before the last delivery orders taken out of sequence—specifically, the tenth and eleventh orders—is pushed back two positions since two delivery orders are made out of sequence. So, barring any other out-of-sequence scenarios of the original eleven orders, the sequence of which is determined by when they are entered into the system, the first, tenth, eleventh, fourth, fifth, second, third, seventh, eighth, sixth, and ninth orders are made successively. The process repeats itself every time a delivery order is made out of sequence if there are more carry-out orders. If there are only delivery orders, it would be considered that the first, tenth, eleventh, second, third, and sixth orders be made successively in the last scenario.

If the program recognizes that the first and tenth orders of ten orders are for delivery and go together, they are made back to back. The second order, a carry-out order, is slated to be made next by the program since the second order is now the oldest order in the store. At this point, the second order has not appeared on the cooks' monitor yet since the cooks are not yet finished making the tenth order. If an eleventh order, another delivery order, is entered into the system that is recognized by the program as compatible with the first and tenth orders, the program sends the eleventh order to the cooks' monitor. Thus, the first, tenth, and eleventh orders are made in sequence. After the first, tenth, and eleventh orders are made, the cooks make the second order, unless there is a special designation on that order such that it is not skipped, which would normally occur on orders for walk-in carry-out or dine-in customers.

At this point, if the second order is a delivery order, the program again sorts the delivery orders, from the remaining backlog of orders, that are compatible with the second order and sends them to the cooks in the order they are most likely to be delivered so as to make the last pizza delivered as hot and fresh as possible. Suppose, for instance, that the first and tenth orders are made, the second order is a carry-out or delivery order that is being made, but not compatible with the first and tenth orders, and the eleventh order, which is recognized by the program to go with the first and tenth orders, is entered into the system. The next order to appear on the screen may be the eleventh order even though not all of the delivery orders in this scenario would be made sequentially. The store determines what time frame is acceptable to form a “double,” a “triple,” or a “quadruple” and what delivery orders are compatible. In addition, the eleventh order may be made after the first and tenth orders have already been placed into the oven if it is likely that the eleventh order will be delivered first because it is closest to the store.

The program allows greater time frames for adding a delivery order to an already formed cluster of delivery orders if the newest order entered into the system is expected to be delivered last or nearly last. Even if the first delivery order only has a few minutes to arrive on time as predicted by the program, if the first order is delivered first, it may arrive on time as well as the other delivery orders. Conversely, smaller time frames are given to newly entered delivery orders that are predicted to be delivered first. Otherwise, delivering them with larger time frames may cause the other delivery orders that are being or already made to arrive later than predicted and, thus, cooler.

At the discretion of the store, the program selects a group of delivery orders to be made first from the delivery orders recognized by the program to have the most compatibility with respect to delivery locations of the orders. For example, the second order is a carry-out order and placed into the oven. Now, the third order, a delivery order, is the oldest order, so it is considered next. But, if the program recognizes the third order to be incompatible with any of the other backlogged delivery orders, the third order may be skipped, such as when the program recognizes that the fifth, sixth, and eighth delivery orders are compatible. The program may also skip the third order if there is a probability that in a short period of time a new delivery order may be entered into the system that is compatible with the third order, which can usually occur during “rush hours.” Skipping the third order shortens the delivery time of the other delivery orders and often maximizes the number of deliveries the store makes in a given time frame, even if no new order compatible with the third order is taken.

If a thirteenth order is later taken and compatible with the third order, the third and thirteenth orders are consecutively made next or very soon and in the order they are likely to be delivered. In this way, two trips to locations proximate each other may be avoided, and the system decreases overall delivery times and increases the delivery capacity of a store with a given number of drivers. So, if the oldest delivery order has no other delivery orders compatible with it, but the program recognizes a good “double” or “triple,” then the “double” or “triple” should be made first, unless the oldest delivery order is becoming so old so as not to be acceptable by the store.

The labor saved by preventing two drivers from delivering the first, tenth, and eleventh orders or the third and thirteenth orders on two trips to locations proximate each other can be focused instead on answering telephones or conducting other routine jobs. Many prospective customers who are “on hold” too long, such as when the store is busy, hang-up the telephone. Sales are lost because sometimes there is not a sufficient number of store employees to answer the telephones. The labor saved through use of the system reduces or eliminates this loss because drivers are more likely to prevent some of the hanging-up of telephones if the drivers are in the store instead of on the road. Thus, the program also increases sales through more telephones being answered through saved labor.

Faster delivery times also increase sales because prospective customers sometimes ask for an estimate of the length of time of delivery. If the estimate is too long, the prospective customers may not order. Also, in general, shorter delivery times please customers, who are more likely to be “repeat” customers.

The program also includes a delay mechanism. Many times, deliveries are made too fast. It is often incorrectly thought that the faster the cooks make delivery orders, the faster the orders arrive at their destinations. In fact, the fast preparation of delivery orders is often harmful to food quality without decreasing delivery times at all. To illustrate, pizza orders sometimes sit for more than fifteen minutes on a shelf because no delivery driver is there to deliver them. The driver may be on the road delivering a distant “triple” and cannot return to the store for thirty minutes. In the meantime, a delivery order may sit on a shelf becoming colder and mushier, causing a loss of customers.

To overcome this problem, the program delays sending delivery orders to the cooks' monitor until sufficiently prior to the return of the next driver such that the pizza order is completed at approximately the same time the next driver arrives at the store. The program is adapted to predict, or a driver can predict, the time he or she will return to the store. The program postpones sending a delivery order or a group of delivery orders to the cooks' monitor until sufficiently prior to the projection time of completion of the order(s), whether it be slightly before or after or at the same time as the arrival of the next driver. As a result, the next order to be delivered is hotter and fresher since it sits less after removal from the oven. This is contrary to the systems of the related art, which send a delivery order or a group of delivery orders to the cooks' monitor immediately.

The program accomplishes this in several ways. When a driver is dispatching himself or herself, but before he or she leaves the store, he or she estimates how long it will take him or her to return. When a driver is dispatched, the program is adapted to know from a driver identification uniquely designated to the driver what delivery orders he or she took and what time he or she left the store. If the driver predicts he or she will return in twenty minutes, for example, and it is projected to take ten minutes to complete the next delivery order or bunch of delivery orders from the time the order or bunch appears on the cooks' monitor, then the next delivery order or bunch is delayed approximately ten minutes. Again, the specific time ranges are at the discretion of the store. Thus, the times of the arrival of the predicted next driver and the completion of the next delivery order(s) substantially intersect.

The program is adapted to calculate the predicted return time of the driver by assessing how far he or she is traveling and how many delivery orders he or she is taking. The program accomplishes this after the driver enters into the system what deliveries he or she is taking and dispatches himself or herself. The program is adapted to estimate a return time that is automatically displayed while the driver can override the program's estimated return time at the time he or she is dispatching himself or herself.

The program can be integrated with the work schedules of delivery drivers. Such integration prevents the program from making erroneous delivery-time estimates. So, at a time prior to the end of the driver's shift, a prompt on the dispatch-display screen, such as “Is this your last delivery?” or the like, allows the program to factor him or her out of future delivery-time estimates if he or answers affirmatively. The prompt is displayed even if his or her work schedule is not used. Using the work schedules aids in the prediction of delivery times, and delivery orders are made in anticipation of arriving scheduled drivers.

Deliveries that do not have driving distances or locations in common are not made consecutively unless there is more than one driver in the store or a driver is projected to arrive nearly at the same time as the second order is predicted to be done. In other words, if there is only one driver clocked-in, both orders may be made consecutively if another driver is scheduled to arrive at the store in time to take the second delivery. They may also be made consecutively if another driver who is currently clocked-in is expected to return about the same time the second order is ready for delivery.

Delivery times predicted by the program are displayed on the monitor of the person who takes the order from the customer soon after the customer's telephone number is entered into the computer and before the customer is off the telephone. The predicted delivery times are updated if they change. This allows the person taking the order to quote the program's time estimations, such as when the order-taker hits an “<order sum>” key, instead of such person estimating the times, as is done with the systems of the related art.

A laser-trip device can be used as a “<next button>.” A hand or finger button would become filthy in short time due to the cooks' hands almost always having food residue on them. If the cooks swipe their hands through a laser, no food will be transmitted onto the laser. Although a keyboard, which is sometimes needed for other purposes, or a footpad works, a trip laser disposed near the monitor is included in a preferred embodiment of the system. A laser “<enter button>” or footpad not only allows for delay in making pizzas, but also is a device to accurately track “make” times. The time gap between inputs using one of these devices can be used in calculating how long pizzas are taking to be made and how far apart delivery orders are in the production process. This information assists the program in estimating delivery and carry-out times. This tracking method is much more accurate than that used in the related art for determining how far apart delivery orders are and how long they actually take to make. Systems in the related art use the time the order is taken, not when it is put into the oven, to form groups of delivery orders that should be taken together, causing dispatching inefficiencies.

Systems in the related art assume it takes the same amount of time to deliver an order from the store to a delivery location for all delivery locations. Obviously, locations farther away from the store take longer to deliver to. Conversely, locations closer to the store take less time to deliver to. To remedy these inaccuracies, the program of the present invention adds or subtracts time to the basic delivery-time estimate, depending upon the distance of the delivery location from the store. The program recognizes by the map coordinates of the delivery location or by other suitable means how far away the delivery location is from the store. The program then adds corresponding time to the basic delivery-time estimate for relatively more distant delivery locations and subtracts corresponding time from the basic delivery-time estimate for relatively closer deliveries. The former are much more likely to be taken last when delivery drivers take multiple delivery orders and extra time is required to complete the transactions of the relatively closest delivery orders.

When taking an order from a customer the address, for instance, of whom is recognized by the program as being that of an apartment or indicated as such to the program by the person taking the order, the program generates a prompt or text inquiring whether a buzzer number, gate code, last name, or the like is needed to get into the apartment complex. It wastes labor and hurts food-product quality for a delivery driver to go to an apartment complex, but be unable to get into it.

Once the program sorts convenient “doubles,” “triples,” or more, it, if possible, sends the orders for them to the cooks' monitor in the order they are likely to be delivered. Almost always, the best way to deliver is to make the order having a delivery location closest to the store first. To exemplify, if three deliveries are selected for a driver, the order having a delivery location farthest from the store is made last so that the order will be as hot as possible, unless another delivery order newly entered into the system is made and compatible with the other orders in the group to form a “double,” “triple,” or whatever. The program, if possible, makes sure that delivery locations farthest from the store, but proximate each other, are bunched together as are delivery locations closest to the store. If it is not so possible, the program is designed to determine delivery routes, more precisely, delivery routes having driving distances in common. Minimal backtracking on the road by delivery drivers is an efficient way to deliver pizza, even if two delivery locations are not close to one another.

The system is further designed to display to the cooks a special message line on the monitor for, as an example, making individual pizzas. The special message line may be blank once a new order is entered such that old messages are not used. To elaborate, a customer may request that two slices of a medium pepperoni pizza include just cheese. Systems in the related art allow only half of a pizza to include just cheese. Or, if a customer requests anchovies on the side, a message noting such request appears in a designated area just above, below, or even beside a description of the pizza on the cooks' monitor. These special messages are typed-in by a customer-service representative of the store at the time of taking the order.

Since backlogs are formed under the system, it is dangerous to have a backlog of orders taken with a possibility that the orders cannot be made due to shortage of dough or other ingredients. The program is designed to monitor the quantity of dough, for example, currently in the store, subtract from or add to that quantity, and display the resulting information on the monitor after each order that includes dough, for instance, is taken. The information can be easily updated by the employees of the store. Therefore, orders that have no possibility of being made are not taken. For example, if a customer orders a large pan pizza, but no dough to make large pan pizzas is available, the person taking the order is given that information. The program also notes the time the store ran out of a particular type of dough such that management of the store is more able to predict how much of that type should be made in the first place. If the store runs out of an item, the program duly takes such notice and makes it impossible to take an order having that item.

After an order is entered into the computer, the program calculates how long it should take to make that order and all the orders that are supposed to be made before the cooks can get to it. The program can then send that order to the cooks' monitor immediately for production of the order if it is the only order to be made, or the program can send it to the cooks' monitor after the cooks make all necessary prior orders.

To prevent carry-out customers from arriving at the store too early, the program can allow for a margin of error in time of, say, five minutes. However, if there is only one order to be made, a shorter margin of error can be given, perhaps three minutes. For instance, if a current order for pizza is predicted to take 45 seconds to make and the time is 7:00:00 p.m., the program can add the “make” time of forty-five seconds; the five-minute margin of error; and ten minutes to cook, cut, and bag the pizza for a total time of fifteen minutes and forty-five seconds. Fifteen minutes and forty-five seconds added to 7:00 p.m. equals 7:15:45 p.m. The person taking the order may round-off that time to the nearest minute, so the projected pick-up time for the carry-out order is quoted to the customer to be 7:16:00 p.m.

If there is a backlog of orders to be made, the estimate of the time to complete the orders can be added to the estimate of the time to complete the current order, resulting in a predicted total “make” time. So, if there are two orders to be made before the current order that are predicted to take a total of two minutes to complete, then two minutes are added to the total “make” time, and, thus, the predicted pick-up time of the current order becomes is 7:18:00 p.m.

Time can be added or subtracted depending upon whether the cooks are making orders in the time the cooks are predicted to make the orders. For example, the program may have predicted previous orders to be completed faster than they actually were. These discrepancies can obviously cause erroneous predictions. To more accurately predict how long it takes to complete a backlog of orders, the program does the following: If the cooks are totally caught-up and a customer-service representative takes an order and enters it into the computer, a sound, a flash, or other like indicator is emitted from or appears on the cooks' monitor that indicates there is at least one pending order to be made now. The cooks see the flashing message and/or hear the sound and hit “<enter>.” Then, the information for that order appears on the cooks' monitor, and the ticket for that order is simultaneously printed. Once the cooks hit “<enter>” and, thus, indicate that they are now making the order, the program calculates the time it takes for the cooks to hit “<enter>” again, indicating the time it took to make the order. If there is a backlog of orders, the program continually adds the time it takes to make each order and calculates the sum. The program then divides that sum by the time the program estimated it would take to make the orders. The resulting figure is the rate at which the cooks are making orders with respect to the program's estimated time to complete those orders. The rate can be used to better estimate the time a backlog of orders takes to complete.

To illustrate, the cooks have just made four of twelve orders in six minutes when the program estimated four minutes to do so. The program divides six by four to get 1.5, the current rate at which the cooks are making orders with respect to the program's estimated time to complete those orders. So, if the program predicted the last eight orders to be completed in ten minutes, the program multiplies the current rate of 1.5 by ten minutes for a total of fifteen minutes. As such, the backlog of the eight orders is expected to take an extra five minutes to complete because the orders are taking longer to complete than initially predicted by the program. Once the cooks have caught-up, this function of the program resets or maintains a rolling average of some past orders.

If the rolling-average method is used, the average time used to calculate the rate may be the average time of the last ten, or some arbitrary number of, orders. So, upon a new carry-out customer calling and his or her order being entered into the computer, the program predicts the time it takes to complete the existing backlog of delivery and carry-out orders, including the current customer's order. The program then calculates the current rate and multiplies that rate by the program's estimate of the time to complete the remaining backlog. So, the program adds the estimated “make” time of the current customer's order to the estimated “make” time of the existing backlog, multiplies the resulting figure by the current rate, and adds the margin of error. The resulting figure is added to the current time of day, which may be rounded-off to the nearest minute and will be the pick-up-time quote for the carry-out customer.

The system is designed to also include a safety mechanism in case the cooks have caught-up from a backlog too quickly. In such a case, new customers' orders are not necessarily delayed being sent to the cooks' monitor when a time gap exists that is longer than the time period designated for margin of error. This way, the order can be fresher when the customer arrives on time. More specifically, when a time gap forms that is larger than the time period designated for margin of error and is a length of time sufficient to fit a new delivery or carry-out order into the time gap, the order may be made prior to all previous orders already in the system. Thus, the most recent order taken may be made in a shorter period of time from when the order was entered into the computer relative to when other orders were entered into the computer.

As an example, if a carry-out order is entered into the computer and there exists a six-minute gap, which is one minute longer than the five-minute margin of error, before the next order is scheduled to be sent to the cooks' monitor, the carry-out order may be made next if it is expected to take less than one minute to make. Alternatively, the most recent order can be made first even if it is predicted to take one minute or longer to complete. In other words, if the most recent order is supposed to take two minutes to complete, it still may be made first. In this instance, if there is any time gap longer than the period for the margin of error, any order may be sent to the cooks' monitor for immediate production, thus, utilizing the margin of error. Hence, the most recent customer may be quoted a pick-up time that is earlier than all of the remaining quoted times for pick-up of carry-out orders.

When an order is sent to the cooks' monitor, but the order is ignored, it may mean a cook is temporarily unavailable to hear or see that there is a pending order to make. Accordingly, a cut-off or maximum amount of time may be allowed to make a single order, say, five minutes. This option may also prevent erroneous time predictions.

When predicting the time it takes to make an order, the program gives each food item of the order a completed-time prediction according to what the item is. For example, a pepperoni pizza may take forty-five seconds, breadsticks may take fifteen seconds, and a cheese pizza may take twenty seconds. Also, the program inventories the number of pre-made items and the amount of dough in the store, which can effect the length of time it takes to prepare certain orders. To wit, if dough for pizza must be rolled-out freshly each time an order for a pizza is made, such an order will take much longer to make than one the dough for which is already rolled-out. Consequently, the system is adapted to categorize an item into various classes. For example, the program may have in its inventory five medium thin-crust pizzas rolled-out. The program may assign no additional time to prepare such pizzas. However, if there are no medium thin-crust pizzas rolled-out, the program may add several minutes to its normal predicted production time to prepare such pizzas.

To estimate delivery times, the program searches for the time the next delivery driver is expected to be back to the store or available for delivery, unless there is a delivery driver already available. Then, the program subtracts from this time the total amount of time expected to make all of the delivery orders of a cluster or group of compatible delivery orders—that is, from the time the order(s) first appear(s) on the cooks' screen to the time it/they is/are bagged. For example, if the next delivery driver is expected to be back to the store at 6:00 p.m., the total expected amount of time to complete the delivery order(s) is thirteen minutes, and the cooks are not running behind, the program starts sending those orders to the cooks' monitor in the order they are likely to be delivered starting at 5:47 p.m. If it becomes 5:47 p.m. and the cooks have run behind while having three carry-out orders to make before they can even get to the cluster of delivery orders scheduled to be made at 5:47 p.m., those delivery orders are made right after those carry-out orders are made. However, those delivery orders may be made on time or almost on time if it is store policy to give priority to delivery orders, but doing so may make the completion of carry-out orders late.

Also, even though the delivery orders are supposed to take thirteen minutes to complete, they may be sent earlier to the cooks' monitor to prevent drivers from having to wait for the orders. This ensures that drivers who arrive back too early do not have to wait for their next group of delivery orders to be finished cooking. The delivery orders may be sent earlier to the cooks' monitor if the cooks are working relatively slowly as well. As another example, if the cooks are running behind by approximately fifteen minutes, the delivery orders are sent to the cooks' monitor at approximately 6:02 p.m., even though to be on time they should have been sent at 5:47 p.m.

To estimate delivery times, the program starts with a base delivery time, which is the average amount of time it takes to deliver an order as soon as it leaves the store. The program adds or subtracts time to the base delivery time based upon the map coordinates of or driving distance to the respective delivery destination from the store. The program then adds time to the base delivery time depending upon the number of delivery orders in a particular cluster of orders and the order in which they will likely be delivered. The program then adds the amount of time expected for all the delivery orders in that cluster to be cooked and bagged.

As an example, a delivery customer's order is just entered into the computer. His or her house is located five minutes farther away from the store than is the average delivery destination, so the program adds five minutes to the base-delivery time of fifteen minutes. But, if his or her house were located five minutes closer to the store than is the average delivery destination, the program would subtract five minutes from the base delivery time of fifteen minutes. If there are multiple orders in the cluster that are to be delivered together, the program adds two minutes or any arbitrary amount of time to each delivery order in that cluster that is likely to be delivered before the current customer's delivery order. So, if there is one delivery order in the cluster that is predicted to be delivered before the current customer's delivery order, then the program adds two minutes, for example.

After a delivery customer calls and his or her address is entered into the system, the program tries to fit his or her delivery order into a delivery cluster from any existing backlog of delivery clusters tentatively formed by the program. Even though these clusters are not rigidly set, they can be used to better estimate delivery times. The number of clusters made is not greater than the number of delivery drivers currently clocked-in. The program then calculates the time it takes either to get to the next available driver or, if the cooks are running behind, to complete the backlog of orders, including the current order. If the cooks are running behind, then the time the cluster will be finished is the program-predicted time for that cluster and all previously pending orders multiplied by the rate. As already stated, the rate is the sum of the actual times divided by the sum of the respective predicted times for the cooks to complete the orders. A rate less than one indicates that there is no delay in preparing the delivery orders in anticipation of an arriving driver. A rate greater than one indicates that the cooks are running behind predicted times. So, if the time it takes to make the existing backlog, excluding delivery orders not part of any formed cluster, surpasses the anticipated arrival time of the next driver, time is added to the delivery-time estimate given to the customer.

For example, a delivery customer calls and has his or her order entered into the computer. There are three clusters of delivery orders that have been formed by the program and are in the order they will be made, but they have not made it to the cooks' monitor yet. There are three drivers currently clocked-in, and all of them are on the road. The first driver is expected to be back in the store at 8:00 p.m., the second driver is expected to be back at 8:05 p.m., and the third driver is expected to be back at 8:10 p.m. The time is 7:55 p.m., and the delivery customer is on the phone. His or her order fits conveniently into the second cluster containing two delivery orders. The second cluster, now consisting of three delivery orders, is expected to take three minutes to prepare and ten minutes to cook and bag. Therefore, the program sends the orders of the second cluster to the cooks' monitor in the order they are likely to be delivered thirteen minutes before the arrival of the second driver, or, 8:05 p.m. Thirteen minutes before 8:05 p.m. is 7:52 p.m., which is three minutes earlier than the current time. Yet, if there are four delivery orders, which are part of the first cluster, and three carry-out orders that must be made before the second cluster can even be tended to, the program adds the projected amount of time for the cooks to make the three carry-out orders, the four delivery orders of the first cluster, and the three delivery orders of the second cluster, into which the current customer's order fits.

Usually, there would not be a long delay in making the delivery orders if the cooks were on schedule. Assuming the program predicts these ten orders to take ten minutes to prepare and the cooks are behind, the rate at which they are making orders is probably greater than one, such as 1.5. The program multiplies 1.5 by ten minutes for a total of fifteen minutes. The program adds this length of time to the current time of 7:55 p.m. to reach 8:10 p.m. This is the time the second cluster of deliveries will likely be prepared and put into the oven. Then, the program adds the cooking and bagging time of ten minutes to the base delivery time of fifteen minutes. Then, the program adds four minutes if that customer's delivery order is likely to be delivered third, two minutes if it is likely to be delivered second, or no time if it is likely to be delivered first. Then, the program may add or subtract time depending upon the map coordinates of the delivery destination or whether the delivery destination is farther from or closer to the store than is the average delivery destination. Then, the program may add a five-minute margin of error to the time the driver is expected to begin making the deliveries, which, since the delivery orders were all put in the oven by 8:10 p.m., is about 8:20 p.m. So, the predicted time of delivery arrival is thirty-four minutes added to 8:10 p.m., which is 8:44 p.m.

Specific times of day may not be the best times to quote for delivery arrivals. Rather, approximations of the total number of minutes may be the best times to quote for delivery arrivals. So, instead of being quoted 8:44 p.m., the customer may be quoted a delivery time of forty-nine minutes.

If the next caller orders a delivery and his or her delivery order is not part of any of the three clusters currently in the backlog, the time quoted to him or her should be approximately 1.5 multiplied by the average amount of time from when each of the last several delivery orders were entered into the system to when the driver pays for it. The program calculates that time automatically. Alternatively, if that delivery order is not part of the three clusters, a prompt may indicate to “ask the manager.”

Alternatively, the program displays all of the delivery orders on the cooks' monitor, perhaps in a column on the left with carry-out orders displayed in another column. Beside each delivery order, the program notes at least the map coordinates of each delivery-order destination and the amount of time elapsed since the order was entered into the system. The time a carry-out order was taken is also noted. The cooks have information as to the status of drivers, such as when the drivers will be back, such that the cooks know approximately when to make orders for the drivers to deliver. The cooks scroll keyboard arrows to whichever order they wish to make. Then, armed with more information with which to make strategic decisions, the cooks scroll to the next order they believe needs to be made.

When the cooks scroll over information identifying an order, such information is highlighted and simultaneously appears on another part of the screen for production of the order. Once that order is done, the cooks hit “<enter>,” and a ticket for that order is printed. Then, that order disappears from the screen, is grouped on another part of the screen with a formed cluster if it is a delivery order, or is indicated as being done. Perhaps, only the map coordinates are noted for each delivery destination of the orders in the cluster. At least the time the last order of each cluster was put into the oven is shown such that that the cooks know if they should make another order to go with the last order.

Information such as customer addresses, the times the orders are taken, and the identifications of the orders can be displayed. In this scenario, the cooks have to try to match the delivery orders that go together based upon updated information. The program can assist in their efforts by indicating the delivery orders known to go together, when the delivery orders were taken, or what time the delivery orders are supposed to be done. This alternative of the system is a significant improvement over the systems of the related art.

There can be time gaps between making delivery-order bunches. The length of these time gaps depends upon how many drivers are available or the discretion used by the store. If there are three drivers, the program can space preparation of consecutive delivery bunches by ten minutes or some arbitrary time gap. Using this method, the store still gains significant increases in the temperature of its delivered pizza and possible savings in labor. Perhaps, most importantly, it regulates the flow of drivers such that the store generally has more people working inside it than being on the road.

Another option is to have the program permit a delivery driver to select for production the delivery orders he or she will be delivering after he or she arrives at the store. This option maximizes the temperature of delivered food since no delivery is made unless a driver is already at the store to deliver it and ensures that an extra employee is in the store. So, basically, if the store is fully staffed of inside workers, the completion of making delivery orders can coincide with drivers arriving at the store. On the other hand, if the store is understaffed, especially of those workers that work inside the store exclusively, the completion of making delivery orders and the arrival of drivers delivering them may be spaced apart and delayed, respectively, so as to have more workers in the store and not on the road. Delaying drivers may increase the store's capacity to deliver more pizzas per any given time frame because more “doubles” and “triples” are formed and fewer “singles” are formed. The store can greatly benefit by having another employee inside it without significantly reducing delivery times, especially during the “rush hours.”

Alternatively, when any driver is dispatched, cashes-in, and/or arrives at the store, another group of delivery orders starts to be made. The program may employ other methods to space drivers as well. For instance, if there is one driver in the store and a delivery-order cluster pending, the orders of the cluster may be delayed for a certain period of time so they are done at approximately the same time the next driver is due back. The next driver due back indicates when he or she is dispatching himself or herself and the time he or she expects to be back. The program can estimate those times also. Then, the program sends the next delivery order or group of delivery orders to the cooks' monitor at a time that allows its completion at approximately the same time the next driver is expected back. Therefore, the driver in the store is able to leave at approximately the same time as the arrival of the next driver. In this way, there is usually a driver in the store to help when it is understaffed. This method can be implemented with more than two drivers as well. When a driver is expected to arrive back, the driver in the store has the orders he or she is delivering ready. If the store is fully staffed, a driver's next delivery order(s) is/are ready to be delivered as soon as he or she is back.

“Future time” orders are orders taken from customers well in advance of when they want them. “Future time” orders have time reserved so they may be completed on time. Therefore, if a “future time” carry-out order includes three pizzas to be done at 7:00 p.m. and is expected to take a total of thirteen minutes to complete, then a period of time from 6:47 p.m. to 6:50 p.m. is reserved expressly to accomplish this task. The cooks may even start earlier to include a margin of error. If the margin of error is five minutes, then a period of time from 6:42 p.m. to 6:45 p.m. is reserved expressly to accomplish this task. If making of a single prior order overlaps this time frame, the order will be made next unless it is a part of a delivery-order cluster the orders of which should be made consecutively. So, as soon as it is 6:43 p.m., the order is sent to the cooks' monitor or is the next in line unless a delivery-order cluster is in the process of being made. These reserved times for delivery and carry-out orders are automatically added to any backlog when determining time predictions for completion of orders.

In addition, “future time” delivery orders have the reserved time necessary for the timely delivery of those orders. For example, if a customer wants a delivery order at 7:00 p.m. that is supposed to take thirty minutes to arrive at the destination from the start of the process, then the order is sent to the cooks' monitor at 6:30 p.m. unless another order is already slated to be made during that time. If two customers want “future time” delivery orders at the same time, the program can note from the employee-work schedule the number of drivers available at that time. If only one driver is in the store at that time, then one of those customers has his or her time preference rejected unless the destinations of those two deliveries have significant driving distances in common. Any driver arriving at the store near that time is assigned to deliver the order and any compatible delivery orders at that time, thus automatically forming a cluster. If a customer calls the store and requests a delivery order a few minutes before the “future time” delivery order is scheduled to be made, the delivery order may be held until after the “future time” delivery order is made unless the delivery order is recognized to be part of the formed or forming “future time” delivery-order cluster. “Future time” delivery orders are automatically the basis in forming the next delivery-order cluster.

An additional option is that more time is added to delivery estimates for delivery orders having destinations far away from the store, even above those estimates to which time has already been added for such far-away destinations, to have the orders held back for a certain period of time until they can be delivered with another delivery or deliveries. It is highly inefficient to deliver far-away-delivery orders by themselves. Any other delivery should be made first, if possible. For example, a delivery-order customer calls, and his or her house is far away. If no delivery orders are made yet and some delivery orders pop-up having destinations closer to the store than is his or her order, then those orders may be made first, even though his or her order was the first order taken. All other delivery and carry-out orders are made before his or her order in the next ten minutes. But, as soon as any delivery order is compatible with his or her order, his or her order then is made. So, as long as the customer's order is not a “single,” the order is made then. Basically, it is held back for a period of time in hopes that a compatible delivery order or orders is/are taken soon.

Preferably, there is an “instant make” or “remake” option for mistakes cooks make that are later discovered. A simple “instant make” button disposed on the computer monitor is sufficient. Then, that delivery order will be given priority, but the program still searches from the backlog for delivery orders having destinations in common. If the cooks make an order in error and must remake a pizza, they input into the computer that the order is a remake such that the program can determine again the other orders, if any, that are compatible with the remake. If it is a carry-out “instant make,” it is the very next order to be made.

If a driver has arrived back at the store before he or she was predicted to return, the program automatically negates his or her predicted return time if it is longer than his or her actual return time. In addition, if a new driver “punches-in,” as indicated by his or her logging into the computer, delivery orders are immediately sent to the cooks for production of the orders provided carry-out orders can still be made as promised. The program knows a driver is back to the store after the driver pays for the delivery orders he or she just delivered because the cashier hits a “<finished>” button to indicate the driver is back and ready to deliver orders again. Or, the driver can input that data into the computer. So, when the driver “punches-in,” at least one delivery cluster can be formed by the program. These clusters are made either when a driver actually arrives at the store or when a driver is expected to be back at the store. So, if a driver is expected to be back at the store at 5:00 p.m., the program has designated the time between 4:37 p.m. and 4:42 p.m., for instance, for these clusters to be made. Now, if a new driver is entered into the system at 4:30 p.m., then that designated time period is eliminated and these clusters are made immediately or as soon as the cooks are caught-up.

If a driver is supposed to take three delivery orders, but, for some reason, he or she elects to take only two orders, the program sends a message to the cooks' monitor inquiring whether the order not taken needs to be re-made. If even only a part of it does, it is now the basis of a cluster of delivery orders. If it is a carry-out order, it is the very next order made. So, if it has one or two delivery orders compatible with it, all are made immediately and in sequential order. A special note appears on the dispatching monitor indicating that this delivery order is very late and needs to be delivered first. If a driver chooses not to take all the delivery orders of the suggested cluster and no order of the cluster that is left behind needs to be re-made, the program sends each order not taken as a “single” unless a compatible order can be made to go with it in time to correspond to the next arriving driver. The single delivery order may be recognized by the program as a new cluster. The program recalculates all the information after every order is taken, every time the cooks hit “<enter>” or trip the laser or footpad, and when the driver has paid for his or her delivery orders.

Making delivery orders faster than there are drivers to deliver them is detrimental. Some delivery locations are just completely incompatible. Even if there is only one driver and only two delivery orders, often only one delivery should be made. This occurs when delivery locations are in different directions from the store and, thus, do not have driving distances in common. If the driver takes both, he or she may pass the store between deliveries without stopping at the store to check whether there are other delivery orders to be delivered to approximately the same location.

In this case, the driver, after making a delivery, indicates to the computer the time he or she is due back to the store such that the program can calculate when the cooks should make any other orders. That would frequently be about the same time he or she leaves the store, but sometimes earlier. This can also reduce delivery times if the delivery order not yet made becomes compatible with another order for an approximately similar location. If these are the only two orders in the store, a ten-minute-countdown clock starts running on the cooks' monitor to inform the cooks how much time they have to do other things before they need to make an order.

In addition, if a “future time” order is supposed to be ready in twenty minutes, a countdown time of fifteen minutes minus the “make” time of the order starts to make sure the cooks notice they have another pending order and when they need to make it. Once the countdown clock runs out, a message and/or sound alert(s) the cooks that an order needs to be made now. The pending orders can be pre-made, and the computer will let the cooks know the time the orders should be put into the oven.

Orders for beverages appear on the dispatching screen as a reminder to drivers and/or all special-delivery messages, perhaps, a flashing message for soda. Drivers often forget beverages, red peppers, or other items, costing the store much revenue per year. Forgetting beverages and condiments angers customers. Drivers are more likely not to forget beverages and condiments if they are displayed on the dispatching screen.

Selecting delivery bunches depends upon a ratio of the number of drivers available or soon to be available to the number of delivery orders that are backlogged. With six drivers, the map can be divided into six sections. With three drivers, the map can be divided into four sections. With two drivers, the map can be divided into two, three, or four sections. With one driver, the map can be divided into two or three sections. With these sectionalized maps, the number of acceptable deliveries to be made in each section can be known, depending upon several factors, including the number of drivers, pending orders, and inside employees. “Doubles,” “triples,” and higher combinations are formed into clusters and/or common driving routes. Again, the orders of the clusters need not be in the same delivery location as long as they have driving routes in common. It is discretionary with the store to decide these parameters. More drivers in the store may cause the program to revert to tighter delivery areas and fewer “doubles,” “triples,” or higher combinations. The availability of fewer drivers allows more liberal determinations in forming “doubles,” “triples,” or higher combinations, just as a higher ratio of pending delivery orders to drivers does. A simple ratio can aid in this determination. Suppose there are ten pending delivery orders and three drivers to make a ratio of roughly 3.33 orders/driver. So, with that ratio, the program limits clusters to three or four orders. Determining the delivery orders that are compatible with each other can be difficult. If a “double” is formed in a tight geographical area and the store is busy, the program searches for a “triple”—thus, one more delivery order. To put it another way, the program searches for a single to include with the “double” that does not break up another “double,” “triple,” or higher combination.

There can also be a checking system that predicts when a delivery driver will return to the store based upon his or her previous actual-return times, throwing out high and low times, to get an average time. This information can be used in estimating the amount of time a driver will take to return to the store. The program also compares the amount of time a carry-out order was predicted to cook to its actual cooking time. This statistical information can be used to adjust computer-time predictions. A driver may even record the time he or she arrives at a delivery destination. Later comparisons of actual times to predicted times may be made to make computer-prediction adjustments.

Finally, there can be a simpler system based upon the same concept as above. The program lists in a column of the cooks' screen all of the delivery orders yet to be made. At the top of the column is the oldest delivery order with the map coordinates of its destination and a timer that displays the amount of time elapsed since that order was taken. All the delivery orders in the column can be grouped by the program using different colors and/or symbols by chronological order, map coordinates, or numbers that indicate the delivery orders known to go together.

The top delivery order or the program-predicted-priority delivery order is highlighted. The contents of the highlighted order is displayed in at least one of several boxes on the screen. If the cooks choose to make this order, they make it and then hit “<enter>.” Then, the ticket for that order will be printed. If the cooks choose not to make this order, they scroll downward. As they do, the summary of the contents of each highlighted order is displayed in at least one box, but possibly several boxes, in the middle of the screen. When they choose to make an order, they simply make it and then hit “<enter>.” If it is a finished delivery order, the number of the order, the map coordinates of the delivery destination of the order, the address of the delivery destination of the order, the time the order was taken, and/or the time the order was put into the oven are displayed in a column on the right side of the screen that consists of non-dispatched orders. Dispatched orders are assumed to have already left the store. Those delivery-order groups in the column on the right side are made to correspond to arriving delivery drivers. So, the predicted time of arriving drivers, the number of drivers currently in the store, and the current time of day are also listed on the screen. Delivery orders that the program determines should not be made currently may have a message to postpone making thereof. Once a carry-out order is done, it simply disappears. After the cooks hit “<enter>,” the highlight bar lights up the next oldest order in the store, which is now on top of the pending-delivery-order column on the left side of the screen.

Alternatively, the program highlights the next delivery or carry-out order the program determines should be made next. Pending carry-out orders do not have to be displayed in a column on the screen. There can be a box designated for carry-out orders with the time the order was taken and is supposed to be done displayed. The carry-out order having an actual in-progress time that is most beyond its promised completion time is displayed in that box. There can simply be a carry-out-order box displaying the order information of at least one carry-out order with the number of carry-out orders pending and the amount of time elapsed since the orders displayed have been taken. If a plurality of boxes are used to display multiple orders, then one of the boxes is highlighted, and after the cooks hit “<enter>,” the contents displayed in that box disappear. If multiple boxes are used, priority numbers are given to the boxes to inform the cooks to which ones they should give priority, or else just the highest-priority order is highlighted after any order is completed.

In the boxes in the middle of the screen, the map coordinates of the delivery destination and/or the time the delivery order was taken are/is also displayed. The cooks choose from the monitor the orders they wish to make in strategic order. The systems of the related art do not include a computer that displays information as to the locations of delivery destinations for consideration, and, thus, the orders are made in a sequential, not a strategic, order.

The more complex embodiments of the system can be combined with the simpler embodiment of the system just described. As soon as an order is made and the cooks hit “<enter>,” the highlight bar moves to the order the program determines is best to make next. Then, the cooks and/or others can override, subtract from, or add to delivery-order clusters that are made to correspond to arriving drivers.

Lastly, a computerized map may be incorporated to assist the cooks in determining what delivery orders are compatible with each other. In conjunction with the computer database or other such source, an image, such as a dot, appears on the computerized map that the cooks can see on the monitor screen and directly corresponds to the actual location of the delivery destination within the delivery area. From the dot on the map, at least the ticket number and, possibly, the elapsed time since the order was taken are indicated. The dots may be color-coded or variously shaped to show the delivery orders, represented by the dots, that the program determines are compatible with each other. Thus, the cooks not having much knowledge of the surrounding circumstances can more easily deduce the delivery orders that are compatible with each other and the order in which they are made. The cooks may use a touch-screen, or they can simply scroll down, make the order, and hit “<enter>.” The dot of the order highlighted on the display screen is circled such that the cooks can quickly find the dot on the map. The dot representing the oldest order may blink. After any delivery order is dispatched, the dot on the map disappears.

The present invention has been described in an exemplary manner. It is to be understood that the terminology that has been used is intended to be in the nature of words of description rather than of limitation.

Many modifications and variations of the present invention are possible in light of the above teachings. Therefore, the present invention may be practiced other than as specifically described.

I claim:

1. A system and method for strategical making, delivery, and carry-out of food orders for use by a store in the business of making, delivering, and permitting carry-out of food such that the food is optimally fresh upon delivery by drivers to and carry-out by customers of the store and wherein said system includes a display, said system and method comprising:
taking and entering into said system new orders from customers of the store for making, delivery, and carry-out of food;
forming groups of the new and pending delivery orders such that the orders of each group have substantially compatible delivery routes or locations;
determining strategically the sequence and timing in which the new and pending delivery and carry-out orders or groups of orders will be made and delivered to delivery customers and picked-up by carry-out customers, respectively, such that the orders are delivered and ready for pick-up in a substantially minimum amount of time upon completion of making the orders; and
displaying the next order or group of orders to be made according to said determination.

2. The system and method for strategical making, delivery, and carry-out of food orders as set forth in claim 1, wherein said determination is based upon the number of delivery and carry-out orders, directions of the substantially compatible delivery routes with respect to the store and distances from the store of the substantially compatible delivery locations, and availability of drivers to deliver the delivery orders.

3. The system and method for strategical making, delivery, and carry-out of food orders as set forth in claim 1, wherein said system further includes an indicator adapted to indicate that the orders or groups of orders have been made and at least one pending order is to be made immediately and to track times.

4. The system and method for strategical making, delivery, and carry-out of food orders as set forth in claim 3, wherein said indicator includes a laser through which a hand can be swiped to indicate that the orders or groups of orders have been made and to track times.

5. The system and method for strategical making, delivery, and carry-out of food orders as set forth in claim 1, wherein said system is adapted to calculate and update estimated amounts of time to complete making of new orders and the pending orders that are to be made before the new orders and times for arrival of orders at delivery locations, readiness for pick-up of orders by carry-out customers, and availability of drivers at the store to deliver the orders.

6. The system and method for strategical making, delivery, and carry-out of food orders as set forth in claim 1, wherein upon orders being displayed, tickets for the orders are generated that include information regarding the respective customers and the orders.

7. The system and method for strategical making, delivery, and carry-out of food orders as set forth in claim 1, wherein said system is adapted to delay displaying delivery orders until sufficiently prior to availability of drivers to deliver the orders such that making of the orders is completed at approximately the time the drivers become available.

8. The system and method for strategical making, delivery, and carry-out of food orders as set forth in claim 5, wherein said system is adapted to be integrated with work schedules of the delivery drivers to allow said system to factor the drivers in or out of future calculated delivery-time estimates.

9. The system and method for strategical making, delivery, and carry-out of food orders as set forth in claim 1, wherein said system further includes map coordinates of the delivery locations to determine distances from the store of and routes to the delivery locations.

10. The system and method for strategical making, delivery, and carry-out of food orders as set forth in claim 1, wherein said system is adapted to generate an inquiry whether means are necessary for the delivery drivers to enter a delivery location.

11. The system and method for strategical making, delivery, and carry-out of food orders as set forth in claim 1, wherein said system is adapted to display special-message lines for making individual orders and to erase such lines upon new orders being entered into said system.

12. The system and method for strategical making, delivery, and carry-out of food orders as set forth in claim 1, wherein said system is adapted to monitor the quantities of particular types of food in the store, subtract from or add to the quantities, display the resulting quantities upon completion of making orders that include the particular types of food, and note the times the store ran out of the particular types of food and not permit entry of orders including the particular types of food.

13. The system and method for strategical making, delivery, and carry-out of food orders as set forth in claim 5, wherein said system is adapted to allow for margins of error in the calculated time estimates.

14. The system and method for strategical making, delivery, and carry-out of food orders as set forth in claim 1, wherein said system is adapted to calculate the rate at which the orders are being made with respect to the calculated estimated amounts of time to make the orders.

15. The system and method for strategical making, delivery, and carry-out of food orders as set forth in claim 13, wherein said system further includes a safety mechanism whereby when time periods between making of orders are formed that are greater than the time periods designated for margins of error and sufficient in which to make new orders, the new orders may be made prior to all pending orders.

16. The system and method for strategical making, delivery, and carry-out of food orders as set forth in claim 5, wherein said system is adapted to, upon calculating estimated amounts of time to complete making of the orders, calculate estimated amounts of time to complete making of each item of the order according to what the item is, to inventory the number of pre-made items in the store such that said system assigns no additional time to prepare such items, and to categorize items into various classes.

17. The system and method for strategical making, delivery, and carry-out of food orders as set forth in claim 1, wherein said system further includes an option for mistakes committed in making orders whereby such orders are given priority while said system determines strategically the sequence and timing in which the priority and pending delivery and carry-out orders or groups of orders will be made and delivered to delivery customers and picked-up by carry-out customers, respectively.

18. The system and method for strategical making, delivery, and carry-out of food orders as set forth in claim 1, wherein said system is adapted to take and enter into said system new orders from dine-in customers of the store for strategical making, delivery, carry-out, and dine-in of food orders for use by a store in the business of making, delivering, and permitting carry-out and dine-in of food such that the food is optimally fresh upon delivery by drivers to and carry-out by and dining of customers of the store.

19. The system and method for strategical making, delivery, and carry-out of food orders as set forth in claim 1, wherein said system is implemented in a computer program and carried-out on a computer system that includes at least a computer having a memory, a processor, the display, and a user-input mechanism.

20. The system and method for strategical making, delivery, and carry-out of food orders as set forth in claim 1, wherein the food orders include orders for pizza-related products.
